(19) United States
(12) Patent Application Publication
(10) Pub. No.: US 2026/0195138 A1
(43) Pub. Date: Jul. 9, 2026

(54) PARALLEL PROCESSING METHOD FOR SINGLE-THREADED PROGRAM

(71) Applicant: TAIZHOU ASKPOWER ELECTRONICS CO., LTD., Taizhou (CN)

(72) Inventor: Zuojin WU, Taizhou (CN)

(21) Appl. No.: 19/563,186

(22) Filed: Mar. 11, 2026

Related U.S. Application Data
(63) Continuation of application No. PCT/CN2024/106716, filed on Jul. 22, 2024.

(30) Foreign Application Priority Data
Aug. 15, 2023 (CN) 202311024414.3
Jul. 16, 2024 (CN) 202410952999.3

(51) Int. Cl. G06F 9/38

(52) U.S. Cl. CPC G06F 9/3887; G06F 9/3838

(57) ABSTRACT

The present application relates to a single-threaded program parallel processing method, which comprises the following steps: identifying N code segments on the basis of a marker for marking code segments, wherein the N code segments are configured to be executed in parallel; and translating the identified N code segments into executable codes, and generating a control block for controlling the parallel execution of the N code segments.

### CROSS-REFERENCE TO RELATED APPLICATIONS

This application is a continuation of International Patent Application No. PCT/CN2024/106716, filed July 22, 2024 and claims priority of Chinese Patent Application No. 202311024414.3, filed on August 15, 2023, and Chinese Patent Application No. 202410952999.3, filed on July 16, 2024. The entire contents of International Patent Application No. PCT/CN2024/106716, Chinese Patent Application No. 202311024414.3, and Chinese Patent Application No. 202410952999.3 are incorporated herein by reference.

### TECHNICAL FIELD

The present application relates to a parallel processing method for a single-threaded program.

### BACKGROUND

Single-threaded programs are characterized by high system stability and strong scalability.

However, during the execution of a single-threaded program, the program path followed follows a sequential order, where preceding processes must be completed before subsequent ones can be executed.

This results in a relatively low execution speed for single-threaded programs.

### SUMMARY

To increase the operation speed of a single-threaded program, the present application provides a parallel processing method for a single-threaded program.

The present application provides a parallel processing method for a single-threaded program, adopting the following technical solution:

a parallel processing method for a single-threaded program, comprising:

identifying N code segments based on markers tagging the code segments, wherein the N code segments are to be executed in parallel; and

translating the identified N code segments into executable codes, and generating a control block for controlling parallel execution of the N code segments.

By adopting the above technical solution, source code of a single-threaded program is tagged to obtain a plurality of code segments capable of being executed in parallel, and the N code segments are translated into executable code to control the parallel execution of the N code segments, thereby achieving computationally parallel processing of the single-threaded program, which is beneficial for increasing the computation speed of the single-threaded program.

Preferably, the method further comprises:

determining whether code segments are able to be executed in parallel with each other based on dependencies between the code segments; and

adding the markers upon determining that the code segments are able to be executed in parallel.

Preferably, the dependencies comprise whether there are mutually dependent parameters, whether there are operations to be performed sequentially, and whether there is a causal relationship.

Preferably, the control block is configured to provide an indicator upon completion of operation of a code segment.

By adopting the above technical solution, based on the indicators, it is determined that after completing the parallel processing of N code segments, the next group of N code segments is then executed in parallel.

Preferably, the control block is configured to control execution of a specific code segment, wherein the specific code segment is any one executable code segment among all code segments to be executed.

By adopting the above technical solution, the time required for different computation modules to execute different code segments may vary. When any computation module becomes idle, that idle computation module immediately executes a subsequent code segment, reducing program computation time.

Preferably, the control block is configured to determine whether a code segment is executable based on code segment execution conditions.

By adopting the above technical solution, it enables controlling the execution of a specific code segment.

In summary, the present application includes at least one of the following beneficial technical effects:

Source code of a single-threaded program is tagged to obtain a plurality of code segments capable of being executed in parallel, and the N code segments are translated into executable code to control the parallel execution of the N code segments, thereby achieving computationally parallel processing of the single-threaded program, which is beneficial for increasing the computation speed of the single-threaded program;

Based on the indicators, it is determined that after completing the parallel processing of N code segments, the next group of N code segments is then executed in parallel.

### BRIEF DESCRIPTION OF THE DRAWING

FIG. 1 is a flowchart of a parallel processing method for a single-threaded program according to Embodiment 1.

### DETAILED DESCRIPTION

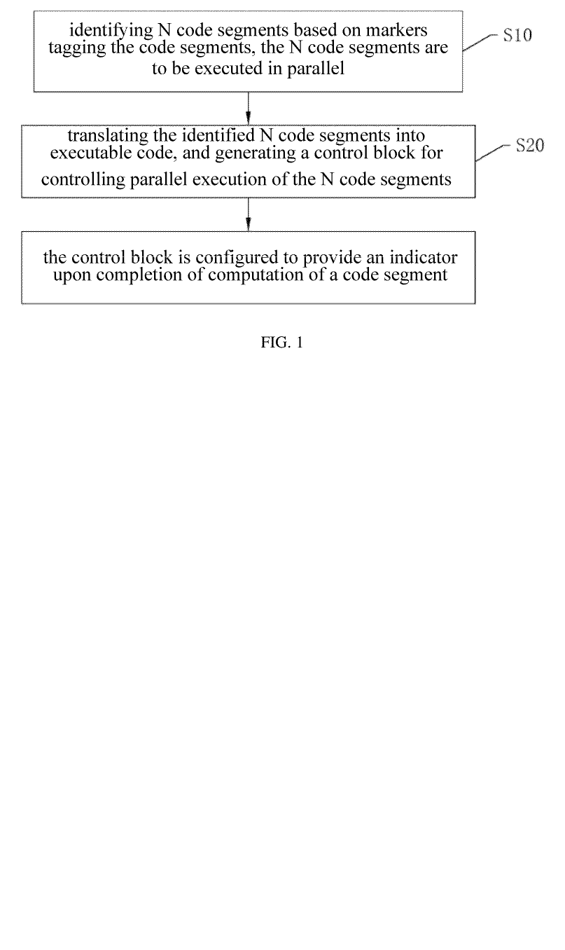

The present application will be further described in detail below with reference to FIG. 1.

The embodiments of the present application disclose a parallel processing method for a single-threaded program.

### Embodiment 1

Referring to FIG. 1, the parallel processing method for a single-threaded program comprises the following steps:

S10, identifying N code segments based on markers tagging the code segments, wherein the N code segments are to be executed in parallel.

Before step S10, the method comprises:

S01, determining whether code segments can be executed in parallel with each other based on dependencies between the code segments.

The dependencies comprise whether there are mutually dependent parameters, whether there are operations that must be performed sequentially, whether there is a causal relationship, etc.

For example, a single-threaded program includes: a code segment 1: A = a1 + a2; a code segment 2: B = b1 + b2; a code segment 3: C = A + ...; and so on.

If a1, a2 are not related to b1, b2, respectively, then it is determined that there is no dependency between code segment 1 and code segment 2, and further determined that code segment 1 and code segment 2 can be executed in parallel.

As another example, a single-threaded program includes: a code segment 1: A = a1 + a2; a code segment 2: B = A + b2; a code segment 3: C = A + ...; and so on.

Then, it is determined that there is a dependency between code segment 1 and code segment 2, and further determined that code segment 1 and code segment 2 cannot be executed in parallel.

Furthermore, the determination primarily relies on automatic program determination; manual determination may be assisted if necessary.

S02, adding the markers upon determining that the code segments can be executed in parallel.

For example, a "coroutine" marker may be used to tag code segments that can be executed in parallel; "async" may also be used, as long as it can mark these code segments as being capable of parallel execution.

S20, translating the identified N code segments into executable code, and generating a control block for controlling parallel execution of the N code segments.

Specifically, multiple cores of a processor are controlled to execute the N code segments respectively, so as to control the parallel execution of the N code segments.

Simultaneously, the control block is configured to provide an indicator upon completion of computation of a code segment, and when the number of indicators equals to N, it is determined that all N code segments have completed operation.

This is used to implement that after completing the parallel processing of N code segments, the next group of N code segments is then executed in parallel.

Implementation principle of the parallel processing method for a single-threaded program according to the embodiment of the present application: Based on dependencies between code segments, source code of a single-threaded program is tagged to obtain a plurality of code segments capable of being executed in parallel, and the N code segments are translated into executable code to control the parallel execution of the N code segments, thereby achieving computationally parallel processing of the single-threaded program, which is beneficial for increasing the computation speed of the single-threaded program.

### Embodiment 2

The difference between this embodiment and Embodiment 1 lies in: the control block is configured to determine whether a code segment is executable based on code segment execution conditions. The control block is configured to control execution of a specific code segment, wherein the specific code segment is any one executable code segment among all code segments to be executed.

The code segment execution conditions include dependencies, causal relationships, data relationships, etc., with respect to code segments currently being executed.

Specifically, the control block controls multiple cores of a processor to execute N code segments respectively;

When a certain core is in an idle state (or ready to execute the next code segment), the control block is configured to control that core to execute any one executable code segment among all code segments to be executed.

The control block is configured to provide an indicator upon completion of computation of a code segment, and whether a core is in an idle state can be determined based on the indicator.

### Embodiment 3

The difference between this embodiment and Embodiment 2 lies in:

the control block is configured to, upon detecting M indicators, control execution of a specific code segment, wherein 1 ≤ M < N; and

the control block is configured to, upon detecting N indicators, control parallel execution of a next group of N specific code segments.

The above are only preferred embodiments of the present application and are not intended to limit the protection scope of the present application. Therefore, any equivalent changes made based on the structure, shape, or principles of the present application shall fall within the protection scope of the present application.

1. A parallel processing method for a single-threaded program, comprising:
identifying N code segments based on markers tagging the N code segments, wherein the N code segments are to be executed in parallel; and
translating the N code segments into executable codes, and generating a control block for controlling parallel execution of the N code segments.

2. The parallel processing method for a single-threaded program according to claim 1, further comprising:
determining whether code segments are able to be executed in parallel with each other based on dependencies between the code segments; and
adding the markers upon determining that the code segments are able to be executed in parallel.

3. The parallel processing method for a single-threaded program according to claim 2, wherein the dependencies comprise whether there are mutually dependent parameters, whether there are operations to be performed sequentially, and whether there is a causal relationship.

4. The parallel processing method for a single-threaded program according to claim 1, wherein the control block is configured to provide an indicator upon completion of operation of a code segment of the N code segments.

5. The parallel processing method for a single-threaded program according to claim 1, wherein the control block is configured to control execution of a specific code segment of the N code segments, wherein the specific code segment is any one executable code segment among all code segments to be executed.

6. The parallel processing method for a single-threaded program according to claim 5, wherein the control block is configured to determine whether a code segment is executable based on code segment execution conditions.
